(19) United States
(12) Patent Application Publication
(10) Pub. No.: US 2018/0373109 A1
(43) Pub. Date: Dec. 27, 2018

(54) DISPLAY FILM

(71) Applicants: TRAM INC., Plymouth, MI (US); KABUSHIKI KAISHA TOKAI RIKA DENKI SEISAKUSHO, Aichi (JP)

(72) Inventors: Makoto HARAZAWA, Novi, MI (US); Shuri ARAKAWA, Ann Arbor, MI (US); Scott Steven ZECH, Ann Arbor, MI (US); Yuichi INAMI, Aichi (JP); Isaac Jordan ELICEA, Taylor, MI (US)

(73) Assignees: TRAM INC., Plymouth, MI (US); KABUSHIKI KAISHA TOKAI RIKA DENKI SEISAKUSHO, Aichi (JP)

(21) Appl. No.: 15/629,029

(22) Filed: Jun. 21, 2017

(51) Int. Cl. G02F 1/153; G02F 1/163

(52) U.S. Cl. CPC G02F 1/1533; G02F 1/163

(57) ABSTRACT

A display film includes a graphic film layer having a displayable graphic and a background color, a switchable film layer, and a color film layer. The switchable film layer is switchable between a clear state and a dark state. When electric power is applied to the switchable film layer, the displayable graphic is either displayed against the background color on a top surface of the display film or only the background color is displayed on the top surface of the display film.

### BACKGROUND

### 1. Field of the Disclosure

The present disclosure relates to the field of display films. More particularly, the present disclosure relates to display films for vehicular instrument control panels, switch knobs, door trims, consoles, dashboards, etc. . . . that include switchable film layers that switch between a clear state and a dark state, depending on whether or not electrical power is applied to the film, to display graphics on the top surface of the film.

### 2. Background Information

Conventionally, blackout dead-front background display films have been used to display graphics on vehicular dashboard control panels. In this technology, the background color of the display film is dark. To display control functions and/or operation states of the various systems in the vehicle, bright graphics are illuminated on the dark background of the display film. To ensure that the bright graphics can be seen in the day light, powerful light emitting diodes (LEDs) are used for day-time illumination. Thus, when no power is applied, the display film retains a black dead-front appearance with no illumination. When power is applied, the black dead-front display film is brightly illuminated to contrast with the dark background to show the control functions and/or operation states of the various vehicular systems.

### 3. Summary of the Disclosure

However, because the background color of the conventional technology is dark (i.e., has a blackout appearance) it is not possible to match white or bright color car interior styling (e.g., cream, light gray, gray, tan, red and blue color interiors, etc. . . . ) to the dead-front appearance of the vehicular dashboard control panels. Thus, the design aesthetic for dead-front film panels has been limited for those vehicles having light color interior styling. In addition, to ensure that day-time illumination is visible to vehicle operators and/or passengers, the powerful LEDs undesirably consume large amounts of power to contrast the displayed control functions and/or operation states of the vehicle against the black background, and thus as a result generate a correspondingly undesirable amount of heat, which reduces the useable life of the film and the housing structure surrounding the film. Furthermore, to compensate for the large amounts of heat generated by the powerful LEDs, the display film housings are typically larger and require more material to withstand/dissipate the heat. This limits the amount of space within the interior of the vehicle, increases the weight of the components, and ultimately increases costs associated with providing these types of display films in the vehicle.

With such existing designs, there is a need for an improved display film that improves the design aesthetic of the dead-front display panels, and enhances options and customization for light color vehicle interior styling, while still effectively displaying the vehicle functions and/or operation states of the various vehicular systems thereon. There is also a need for an improved display film that reduces energy consumption and heat to increase the shelf life of the display film, while also allowing for more compact housing design to reduce material waste and costs.

According to non-limiting embodiments of the present application, a display film is provided. The display film may include a graphic film layer having a displayable graphic and a background color, a switchable film layer, and a color film layer. The switchable film layer is switchable between a clear state and a dark state when electric power is applied to the switchable film layer to either display the graphic on a top surface of the display film or only display the background color on the top surface of the display film.

In embodiments, when the graphic is displayed, the graphic is a color darker than the background color against which it is displayed on the top surface of the display film.

In embodiments, the graphic film layer is provided at an uppermost side of the display film, the switchable film layer is provided between the graphic film layer and the color film layer, and the switchable film layer is switchable between the clear state and the dark state when electric power is applied to the switchable film layer to either display the graphic against the background color on a top surface of the graphic film layer or only display the background color on the top surface of the graphic film layer.

In embodiments, the switchable film layer is provided at an uppermost side of the display film, the graphic film layer is provided between the switchable film layer and the color film layer, and the switchable film layer is switchable between the clear state and the dark state when electric power is applied to the switchable film layer to either display the graphic and the background color through a top surface of the switchable film layer or only display a color of the switchable film layer corresponding to the background color.

In embodiments, in the clear state, the graphic is displayed against the background color on the top surface of the graphic film layer, and in the dark state, only the background color is displayed on the top surface of the graphic film layer.

In embodiments, when the graphic is displayed, the graphic is a color that corresponds to a color of the color film layer.

In embodiments, switching from the clear state to the dark state has a fade-effect on the graphic such that only the background color is displayed on the top surface of the graphic film layer, and switching from the dark state to the clear state has a reveal-effect on the graphic such that the graphic is displayed against the background color on the top surface of the graphic film layer.

In embodiments, in the dark state, no electric power is applied to the switchable film layer and only the background color is displayed on the top surface of the graphic film layer, and in the clear state, electric power is applied to the switchable film layer to display the graphic against the background color on the top surface of the graphic film layer.

In embodiments, in the clear state, only the background color is displayed on the top surface of the graphic film layer, and in the dark state, the graphic contrasts with the background color to be displayed on the top surface of the graphic film layer.

In embodiments, the background color of the graphic film layer corresponds to a color of the color film layer.

In embodiments, switching from the clear state to the dark state has a reveal-effect on the graphic such that the graphic is displayed against the background color on the top surface of the graphic film layer, and switching from the dark state to the clear state has a fade-effect on the graphic such that only the background color is displayed on the top surface of the graphic film layer.

In embodiments, when electric power is applied to the switchable film layer in the dark state, the switchable film layer is switched to the clear state such that only the background color is displayed on the top surface of the graphic film layer, and when electric power is applied to the switchable film layer in the clear state, the switchable film layer is switched to the dark state such that the graphic is displayed against the background color on the top surface of the graphic film layer.

In embodiments, in the dark state, no electric power is applied to the switchable film layer state such that the graphic is displayed against the background color on the top surface of the graphic film layer, and in the clear state, electric power is applied to the switchable film layer such that only the background color is displayed on the top surface of the graphic film layer.

In embodiments, the switchable film layer is configured to continuously receive the electric power in the clear state.

In embodiments, the switchable film layer is configured to temporarily receive the electric power to switch between the clear state and the dark state.

In embodiments, the electric power may be one of alternating current voltage and direct current voltage.

In embodiments, the switchable film layer may be one of a polymer disbursed liquid crystal film, a suspended polymer device film layer, and an electrochromic film layer.

Other aspects and advantages of the present disclosure will become apparent from the following description taken in conjunction with the accompanying drawings, illustrated by way of example, the spirit of the invention.

### BRIEF DESCRIPTION OF THE DRAWINGS

The novel features which are characteristic of the various embodiments of the display film, both as to structure and method of operation thereof, together with further aims and advantages thereof, will be understood from the following description, considered in connection with the accompanying drawings, in which embodiments of the display film are illustrated by way of example. It is to be expressly understood, however, that the drawings are for the purpose of illustration and description only, and they are not intended as a definition of the limits of the display film. For a more complete understanding of the disclosure, as well as other aims and further features thereof, reference may be had to the following detailed description of the disclosure in conjunction with the following exemplary and non-limiting drawings wherein:

FIG. 1 shows an exploded plan view of an exemplary, non-limiting embodiment of a display film in a dead-front state, according to aspects of the present disclosure.

FIG. 2 shows an exploded plan view of an exemplary, non-limiting embodiment of the display film of FIG. 1 in a display state, according to aspects of the present disclosure.

FIG. 3 shows a first exemplary, non-limiting example of a switchable film layer in a clear state and in a dark state, according to aspects of the present disclosure.

FIG. 4 shows an exploded plan view of a second exemplary, non-limiting embodiment of a display film in a dead-front state, according to aspects of the present disclosure.

FIG. 5 shows an exploded plan view of an exemplary, non-limiting embodiment of the display film of FIG. 4 in a display state, according to aspects of the present disclosure.

FIG. 6 shows an exploded plan view of a third exemplary, non-limiting embodiment of a display film in a dead-front state, according to aspects of the present disclosure.

FIG. 7 shows an exploded plan view of an exemplary, non-limiting embodiment of the display film of FIG. 6 in a display state, according to aspects of the present disclosure.

FIG. 8 shows a second exemplary, non-limiting example of a switchable film layer in a clear state and in a dark state, according to aspects of the present disclosure.

FIG. 9 shows a chart summarizing display control of the display films and operating state of the switchable film layers of the first, second and third exemplary, non-limiting embodiments.

FIG. 10 shows an exploded plan view of a fourth exemplary, non-limiting embodiment of a display film in a dead-front state, according to aspects of the present disclosure.

FIG. 11 shows an exploded plan view of an exemplary, non-limiting embodiment of the display film of FIG. 10 in a display state, according to aspects of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Structures, operations and/or methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular. In addition, reference to a dead-front, dead front background, dead-front display film panel and the like, is intended to refer to the appearance state of the display panel when a seamless, uniform background color is presented and no graphics are displayed thereon.

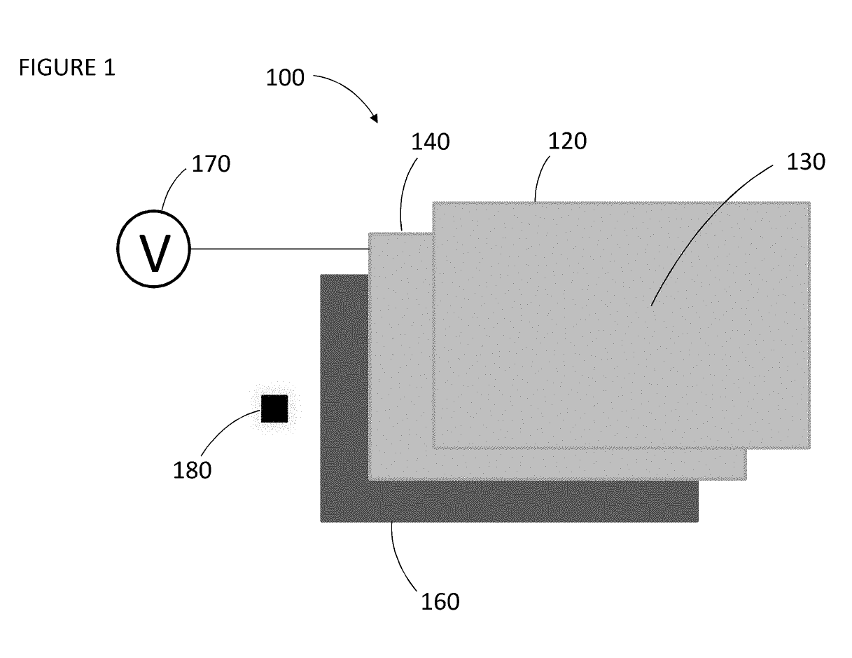

FIG. 1 illustrates a first non-limiting embodiment of a display film 100 in a dead-front state having a light color dead-front appearance. The display film 100 includes multiple film layers including a graphic film layer 120, a switchable film layer 140, and a color film layer 160. While three film layers are shown for illustration purposes, additional film layers may be included as part of the display film 100. For example, including one or more additional polarized film layers, graphical image layers, protective film layers, color enhancing film layers, or any other film layers that control color, light transmission, reflection and refraction to enhance the images being displayed or the dead-front appearance when the images are not displayed is contemplated and intended to be within the spirit and the scope of the present application. The film layers are vertically stacked together and may be custom-shaped to fit within various housings (for example, within housings for vehicular instrument control panels, switch knobs, door trims, consoles, dashboards, shifters, etc). The film layers of the display film 100 may be laminated together, adhered together via an adhesive (for example, adhesive tape or glue), clamped together via a clamping structure or mechanism to set the relative positioning between film layers, or any other known manner in which display films are stacked in a compressed or sandwiched state, although it is contemplated that any one or more of the film layers may be spaced from any other one or more film layers in the stacked state as well. It is further contemplated that the display film 100 may also be employed with other types of consumer products that require control over/display of various functions and/or operation states (for example, refrigerators, air conditioning control display panels, microwaves, dishwashers, washing machines, dryers, etc. . . . .)

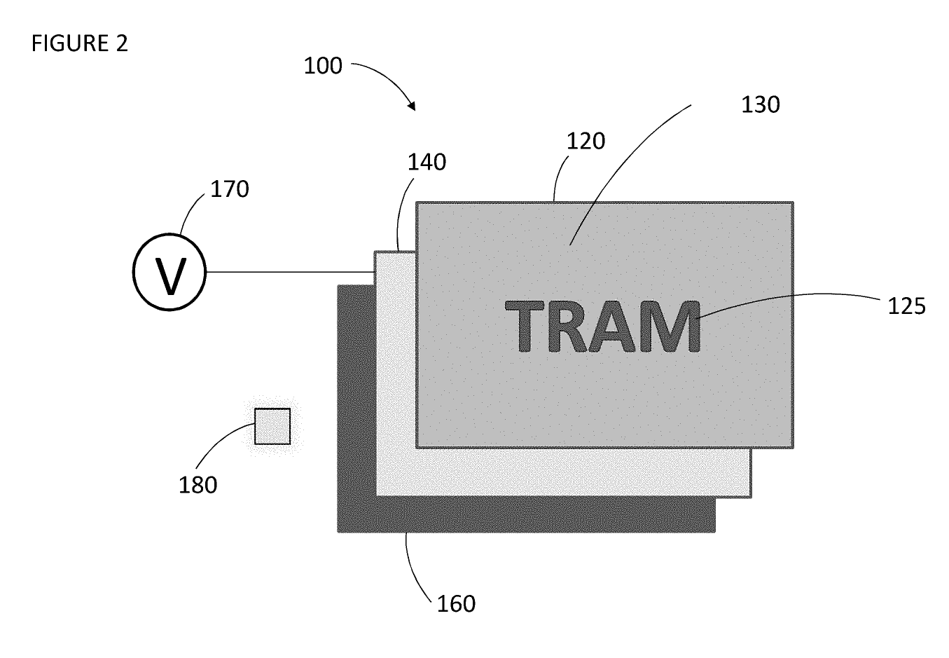

FIG. 2 illustrates the display film 100 in a display state where the light color dead-front transforms to display graphics on a top surface thereof. As shown, the graphic film layer 120 is provided at an uppermost side of the vertically stacked display film 100 and includes displayable graphics 125 (for example, numbers, letters, words, symbols, etc. . . . ) and has a background color 130 (any color is suitable so long as the color is lighter than the color of the graphics being displayed). The background color 130 surrounds the portion of the graphic film layer 120 that includes the displayable graphics 125. As will be described in detail below, when the switchable film layer 140 is in a clear state, the displayable graphics 125 are displayed on the top surface of the graphic film layer 120. When the graphics 125 are displayed, the graphics 125 are a color darker than the background color 130 of the graphic film layer 120 against which they are displayed on the top surface of the display film 100.

The displayable graphics 125 may be provided to the graphic film layer 120 by any known method or technique for providing graphics to a film layer such as, for example, laser etching, masking, printing and painting. However, for purposes of the present application the known methods or techniques by which the graphics 125 are provided to the graphic film layer 120 are not particularly limited and may be chosen based on the suitability of their particular application so long as when the graphics 125 are displayed, they are a color that is darker than the background color 130 against which they are displayed. In addition, the material of the graphic film layer 120 is also not particularly limited and may be chosen from known materials for laser etching, masking, printing and painting graphics to the film layer (for example, polymer films, polarizers, glass, metal, paint layer of the switchable film layer 140, or any other known material capable of being formed into a thin sheet and receiving a graphic thereon). In the present embodiment, the graphics 125 are a clear/transparent portion of the graphic film layer 120 such that the displayable graphics 125 have the same color as a color of the color film layer 160 when the graphics are displayed.

The switchable film layer 140 is provided between the graphic film layer 120 at an uppermost side of the display film 100 and the color film layer 160 is provided at a bottom-most side of the display film 100. As shown in FIG. 2, a voltage source 170 (for example a battery, a motor, a solar photovoltaic cell), which supplies the electrical power to the switchable film layer 140, is connected to the switchable film layer 140. The switchable film layer 140 is switchable between a dark state and a clear state when electric power is applied to the same. When power from the voltage source 170 is supplied to the switchable film layer 140, the switchable film layer 140 transforms from the dark state to the clear state and becomes transparent or translucent to allow the displayable graphics 125 to be shown on the upper surface of the display film 100. Optionally, a light source 180 may be provided for illuminating the displayable graphics 125 on the upper surface of the display film 100 when the switchable film layer 140 is in the clear state. In this regard, the switchable film layer 140 is in the clear state when light from the light source 180 (for example, light from an LED provided on a printed circuit board below the color film layer 160) is able to pass through the film layer to illuminate the upper surface of the display film 100 with the displayable graphics 125.

When power supplied from the voltage source 170 is turned off, the switchable film layer 140 transforms from the clear state to the dark state and presents a light color dead-front appearance (which will be discussed in detail below) on the upper surface of the display film 100. If the light source 180 is provided, in the dark state the light from the light source 180 is prevented from passing through the film layer and otherwise deflected from or reflected off of an outer surface of the film layer. In the dark state, the switchable film layer 140 may be opaque or have a dark hue such that the film layer is not transparent or translucent and blocks light transmission through it. Thus, the switchable film layer 140 includes properties that allow it to change its transparency based on whether or not electric power has been applied to it.

In the present embodiment, the switchable film layer 140 is a polymer disbursed liquid crystal film (PDLC). However, it is contemplated that alternative known switchable films may be employed so long as when electric power is applied or removed, the film's transparency changes such that graphics can be displayed on the upper surface of the display film 100 (for example, a dark graphic displayed against a light color background) or no graphics are displayed (for example, only a light colored dead-front appearance is presented).

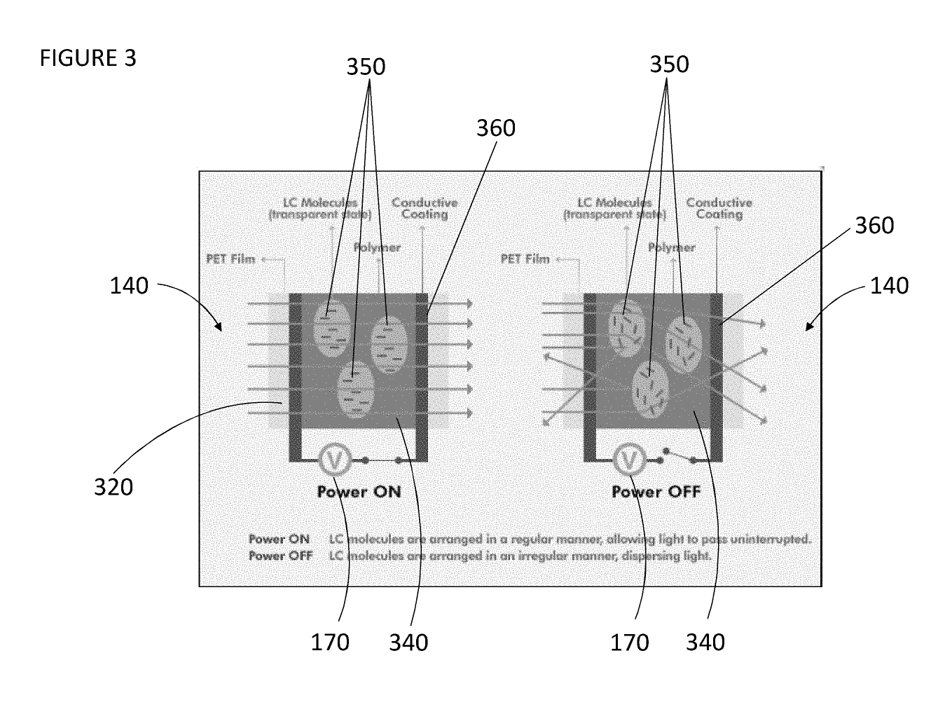

FIG. 3 shows a schematic of the switchable film layer 140 when the PDLC film is employed. As shown, the PDLC film includes at least a polymer film layer 320 (for example, a polyethylene terephthalate (PET) layer), a liquid polymer layer 340 including liquid crystal molecules 350, and a conductive coating layer 360. In this example, the liquid polymer layer 340 is disposed between the polymer film/conductive coating layers 320, 360. With such a construction, when electric power via the voltage source 170 is received by the switchable film layer 140, current flows (power ON) and each liquid crystal molecule 350 within the liquid polymer layer 340 is activated into parallel alignment. Alignment of the liquid crystal molecules 350 transforms the switchable film layer 140 from being in the dark state (for example, opaque) to being transparent (i.e., in the clear state) and permits the displayable graphics 125 to be shown. In addition, when the light source 180 is provided, light from the light source 180 is permitted to pass through the transparent film layer.

When no electric power is applied to the switchable film layer 140, no current flows (power OFF) and each liquid crystal molecule 350 within the liquid polymer layer 340 is shifted from the aligned arrangement in a random, irregular arrangement to transform the switchable film layer 140 from being transparent to being in the dark state (for example, opaque). In the dark state, the light color dead-front appearance is presented on the upper surface of the display film 100. When the light source 180 is provided, light from the light source 180 is also prevented from passing through the switchable film layer 140. When the switchable film layer 140 is a PDLC film, the voltage source 170 is an alternating current voltage source (for example an electric induction motor) and the switchable film layer 140 is configured to continuously receive the electric power to be retained in the clear state.

The color film layer 160 may be many different colors and is not particularly limited (e.g., black, blue, yellow, red, purple, green, orange, white, pink, tan, gray, etc. . . . ) so long as the displayable graphics 125 contrast against the background color 130 of the graphic film layer 120. With the PDLC film, the color film layer 160 serves as the color of the displayable graphics 125 when the switchable film layer 140 is in the clear state. In addition, the material of the color film layer 160 is also not particularly limited and may be chosen from known materials for color films (for example, plastics, metal, paint layer of the switchable film layer 140, etc. . . . ).

Next, with reference to FIGS. 1-3, the operation of the display film 100 incorporating the PDLC film as the switchable film layer 140 will be described.

As shown in FIG. 1, in the dark state, no electric power from the voltage source 170 is applied to the switchable film layer 140 and thus only the background color 130 of the graphic film layer 120 is displayed on the top surface of the graphic film layer 120. In this regard, the displayable graphics 125 are clear/transparent portions of the graphic film layer 120 and thus blend into the background color 130 since the switchable film layer 140 is in the dark state and blocks the color film layer 160 from being directly visible through the clear area defining the displayable graphics 125.

As shown in FIG. 2, in the clear state, electric power from the voltage source 170 is applied to the switchable film layer 140 to display the graphics 125 against the background color 130 on the top surface of the graphic film layer 120. In this regard, the graphics 125 contrast against the lighter color of the background color 130 since the color film layer 160 is directly visible through the clear areas defining the graphics 125. Thus, the color of the displayed graphics 125 matches the color of the color film layer 160.

Further, when no electric power is applied to the switchable film layer 140, each liquid crystal molecule 350 within the liquid polymer layer 340 is randomly/irregularly arranged causing the film to transform into the dark state (i.e., take on an opaque appearance). When the light source 180 is provided, the film layer reflects light from the light source 180. When the switchable film layer 140 is in the dark state, only the background color 130 of the graphic film layer 120 is displayed on the top surface of the graphic film layer 120 to give the display film 100 the light color dead-front appearance.

However, as shown in FIG. 2, when electric power is applied to the switchable film layer 140, current flows and each liquid crystal molecule 350 within the liquid polymer layer 340 is activated to align parallel. The parallel arrangement of the liquid crystal molecules 350 allow the film to be transparent (i.e, in the clear state) and therefore permits the graphics 125 to be displayed on the upper surface of the display film 100. When the light source 180 is provided, the switchable film layer 140 also permits light from the light source 180 to pass through so that the graphics 125 can be displayed. As explained above, when the graphics 125 are displayed, the graphics 125 are a color that corresponds to a color of the color film layer 160. In addition, when the graphics 125 are displayed, the graphics 125 are a color darker than the background color 130 of the graphic film layer 120 against which it is displayed on the top surface of the graphic film layer 120.

Switching from the clear state to the dark state has a fade-effect on the displayable graphics 125. The fade-effect may be defined as a smooth transition (gradually or instantaneously) where the displayable graphics 125 fade, blend, dissipate, disappear or are submerged into the background color 130 of the graphic film layer 120 such that only the background color 130 is displayed on the top surface of the graphic film layer 120. Conversely, switching from the dark state to the clear state has a reveal-effect on the displayable graphics 125. The reveal-effect may be defined as a smooth transition (gradually or instantaneously) where the displayable graphics 125 seamlessly emerge or appear from the background color 130 into focus to contrast with the background color 130 such that the displayable graphics 125 are displayed against the background color 130 on the top surface of the graphic film layer 120.

When the display film 100 employs the PDLC film as the switchable film layer 140, switching between the clear state and the dark state is perceived as instantaneous and seamless so that the graphics 125 appear repeatedly, quickly and clearly, and disappear just as quickly and smoothly. Since the displayable graphics 125 are darker in color than the background color 130 (thereby creating a strong contrast between the two colors), visibility issues associated with the conventional technology in day-time high-glare or brightness situations can also be effectively avoided. Employing the PDLC film thus results in an improved design aesthetic so that when, for example, the technology is applied to a vehicle control panel, the resulting transition between the display state and the light color dead-front state of the display film 100 is pleasing to the eye and reliably accurate between each transition. Additionally, the PDLC film has a uniform color appearance in the dark state/opaque condition, which allows for easy color matching with various colored graphic film layers 120/color film layers 130, and thus improves customization of the display film 100 in both the dead-front state and in the display state. Further, the PDLC film is capable of a high degree of transparency in the clear state, and thus the graphic images 125, as well as their color(s), can be more brightly and clearly displayed. Still further, the PDLC enhances power savings and reduces heat generation since the film is not operational until the electric power is applied. Moreover, when the electric power is applied the graphics are reliably displayed since the AC voltage source 170 continuously supplies power to the switchable film layer 140 to maintain the display film 100 in the display state. In addition, because the light source 180 is optionally provided, further reduction in heat generation and power savings can be achieved since power is only required to change the state of the switchable film layer 140 to display the graphics 125 or present the light color dead-front appearance.

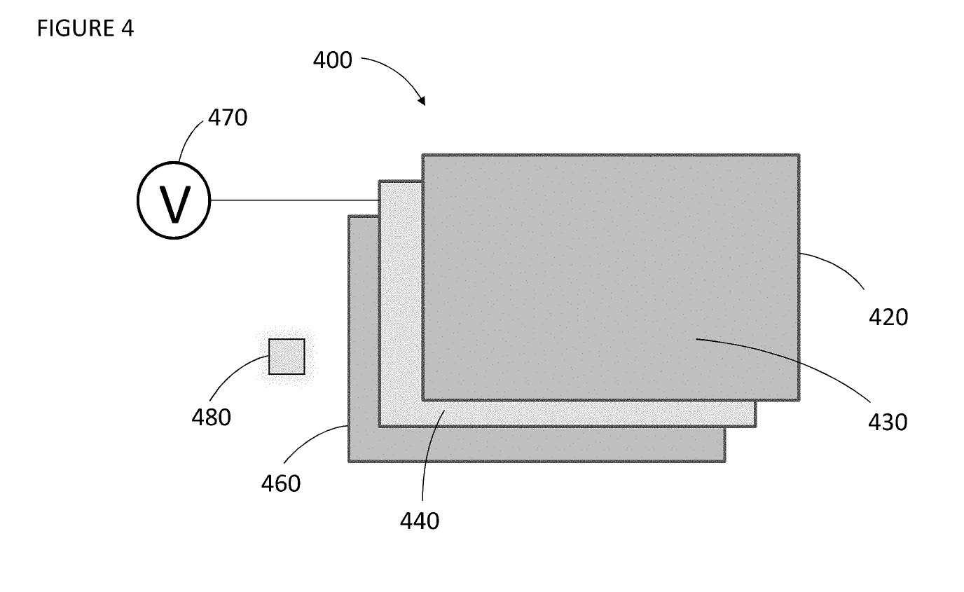

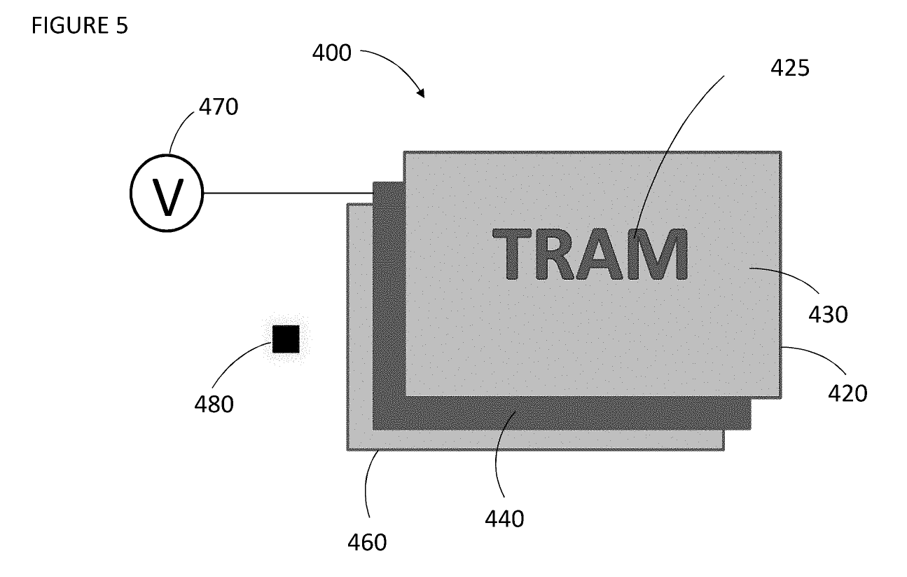

FIG. 4 illustrates a second non-limiting embodiment of a display film 400 in a dead-front state having a light color dead-front appearance. The display film 400 includes multiple film layers including a graphic film layer 420, a switchable film layer 440, and a color film layer 460. FIG. 5 illustrates the display film 400 in a display state where the light color dead-front transforms to display graphics on a top surface thereof. As shown in FIGS. 4 and 5, the graphic film layer 420 is provided at an uppermost side of the vertically stacked display film 400, includes displayable graphics 425, and has a background color 430. The background color 430 surrounds the portion of the graphic film layer 420 that includes the displayable graphics 425. The switchable film layer 440 is provided between the graphic film layer 420 at the uppermost side of the display film 400 and the color film layer 460 provided at a bottom-most side of the display film 400. Similar to the first embodiment, a voltage source 470 is connected to the switchable film layer 440 and a light source 480 is optionally provided below the color film layer 460.

In the present embodiment, the switchable film layer 440 is a suspended polymer device film (SPD). When the switchable film layer 440 is a SPD film, the voltage source 470 is an alternating current voltage source (for example an electric induction motor) and the switchable film layer 440 is configured to continuously receive the electric power to be retained in the clear state. It is noted that the SPD film functions similar to the PDLC film with respect to applying electric power and switching between the clear state and the dark state, and thus further discussion of the same has been omitted.

It is contemplated that alternative known switchable films may be employed so long as when electric power is applied or removed, the films transparency changes such that graphics can be displayed on the upper surface of the display film 400 (for example, a dark graphic displayed against a light color background) or no graphics are displayed (for example, only a light colored dead-front appearance is presented).

Next, with reference to FIGS. 4 and 5, the operation of the display film 400 incorporating the SPD film as the switchable film layer 440 will be described.

As shown in FIGS. 4 and 5, the voltage source 470, which supplies the electrical power to the switchable film layer 440, is connected to the switchable film layer 440 such that, depending on whether or not electric power is applied to the same, the switchable film layer 440 is switched between a dark state and a clear state. Unlike the switchable film layer 140 of the first embodiment, however, when the switchable film layer 440 is in the clear state, the displayable graphics 425 are not shown and only the background color 430 is shown on the upper surface of the display film 400 to achieve the light color dead-front appearance. When the light source 480 is provided, light from the light source 480 is able to pass through the film layer to illuminate the upper surface of the display film 400 with only the background color 430 to achieve the light color dead-front appearance. However, similar to the switchable film layer 140 of the first embodiment, the switchable film layer 440 may be transparent or translucent in the clear state.

The switchable film layer 440 is in the dark state when the displayable graphics 425 are shown on the upper surface of the display film 400. When the light source 480 is provided, light from the light source 480 is prevented from passing through the film layer and is otherwise deflected from or reflected off of the surface of the film layer. As shown in FIG. 5, when the switchable film layer 440 is in the dark state, the switchable film layer 440 may be opaque or have a dark hue such that the film layer is not transparent or translucent and blocks light transmission therethrough. In other words, in the dark state, no electric power from the voltage source 470 is applied to the switchable film layer 440 to display the graphics 425 against the background color 430 on the top surface of the graphic film layer 420. Here, the color of the color film layer 460 cannot be visualized on the top surface of the graphic film layer 420. Thus, when the graphics 425 are displayed, the graphics 425 are a color that corresponds to a color of the switchable film layer 440. In addition, when the graphics 425 are displayed, the graphics 425 are a color darker than the background color of the graphic film layer 420 against which they are displayed on the top surface of the graphic film layer 420. Further, in the clear state of the switchable film layer 440, the color film layer 460 has the same color as the background color 430 of the graphic film layer 420 to achieve the light color dead-front appearance.

Switching between the clear state and the dark state of the SPD film also has the above-described reveal-effect and fade-effect on the graphics 425, respectively, such that the graphics 425 are either displayed against the background color 430 on the top surface of the graphic film layer 420 or such that only the background color 430 is displayed on the top surface of the graphic film layer 420.

When the display film 400 employs the SPD film as the switchable film layer 440, switching between the clear state and the dark state is perceived as instantaneous and seamless so that the graphics 425 appear repeatedly, quickly and clearly, and disappear just as quickly and smoothly. Since the displayable graphics 425 are darker in color than the background color 430 (thereby creating a strong contrast between the two colors), visibility issues associated with the conventional technology in day-time high-glare or brightness situations can also be effectively avoided. Employing the SPD film thus results in an improved design aesthetic so that when, for example, the technology is applied to a vehicle control panel, the resulting transition between the display state and the light color dead-front state of the display film 400 is pleasing to the eye and reliably accurate between each transition. Additionally, due to the switching nature of the SPD film, customizability of the display film 400 in both the dead-front state and in the display state is improved. Further, the SPD film is capable of a high degree of transparency in the clear state, and thus the color of the color film layer 460, as well as the color of the background color 430 of the graphic film layer 425, enable the light color dead-front state of the display film 400 to be more richly, uniformly and consistently displayed for a pleasing visual effect. In addition, because the light source 480 is optionally provided, further reduction in heat generation and power savings can be achieved since power is only required to change the state of the switchable film layer 440 to display the graphics 425 or present the light color dead-front appearance.

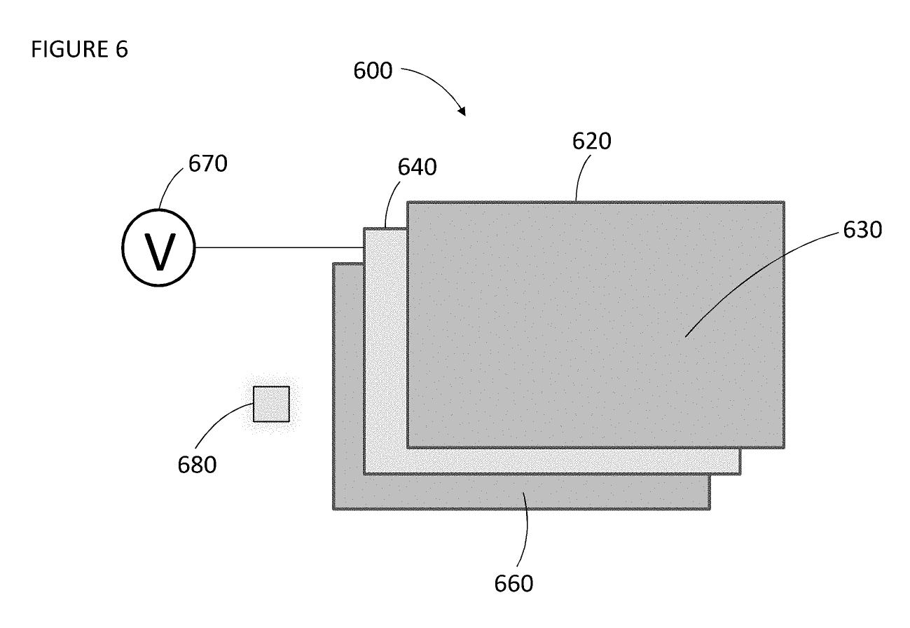

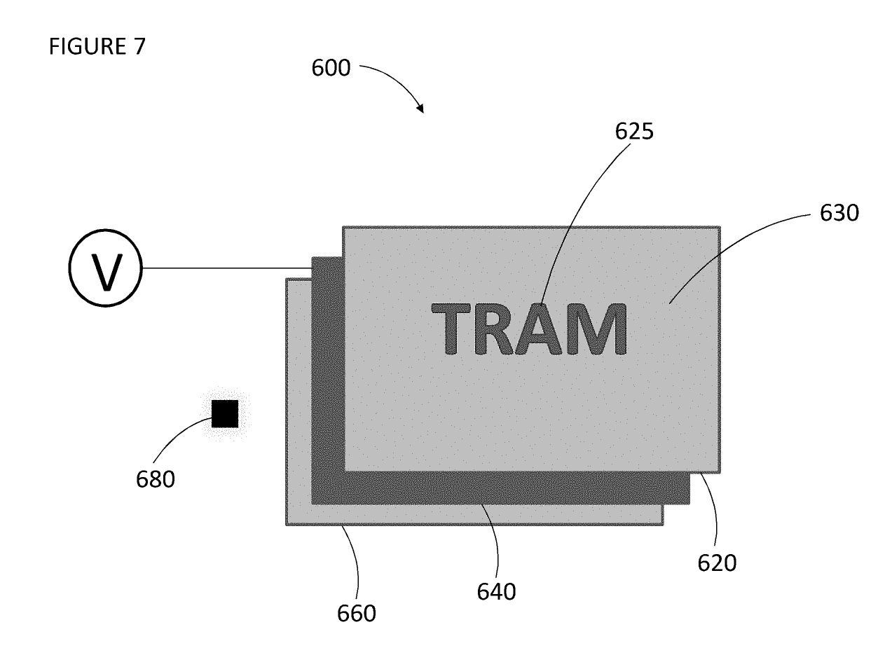

FIG. 6 illustrates a third non-limiting embodiment of a display film 600 in a dead-front state having a light color dead-front appearance. Similar to the first and second embodiments, the display film 600 includes multiple film layers including a graphic film layer 620, a switchable film layer 640, and a color film layer 660. FIG. 7 illustrates the display film 600 in a display state where the light color dead-front is transformed to display graphics on a top surface thereof. As shown in FIGS. 6 and 7, the graphic film layer 620 is provided at an uppermost side of the vertically stacked display film 600, includes displayable graphics 625, and has a background color 630. The background color 630 surrounds the portion of the graphic film layer 620 that includes the displayable graphics 625. The switchable film layer 640 is provided between the graphic film layer 620 at the uppermost side of the display film 600 and the color film layer 660 provided at a bottom-most side of the display film 600. Also similar to the first and second embodiments, a voltage source 670 is connected to the switchable film layer 640 and optionally a light source 680 is provided below the color film layer 660.

In the present embodiment, the switchable film layer 640 is an electrochromic (EC) film. When the switchable film layer 640 is an EC film, the voltage source 670 is a direct current voltage source (for example battery) and the switchable film layer 640 is configured to temporarily receive the electric power to switch between the clear state and the dark state as will be described in detail below.

It is contemplated that alternative known switchable films may be employed so long as when electric power is temporarily applied or removed, the film's transparency changes such that graphics can be displayed on the upper surface of the display film 600 (for example, a dark graphic displayed against a light color background) or no graphics are displayed (for example, only a light colored dead-front appearance is presented).

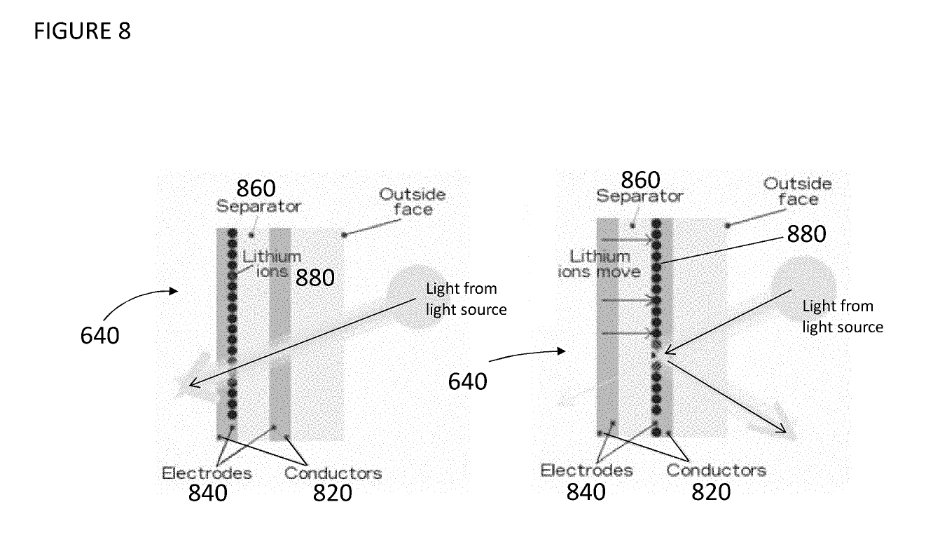

FIG. 8 shows a schematic of the switchable film layer 640 when an EC film is employed. As shown, the EC film 640 includes two outermost-side conductors 820, one of the outermost-side conductors 820 being disposed on a side opposite to a displayable graphics side of the film (when the light source 680 is provided, the one conductor being disposed on a light source-side of the film). Each outermost-side conductor 820 includes an interior-side electrode 840 connected at an inner side of each conductor 820. A separator 860 is disposed between the two interior-side electrodes 840 to space the electrodes 840 from each other and to allow lithium ions 880 to move back and forth between the two interior electrodes 840.

With such a construction, when electric power via the voltage source 670 is received by the switchable film layer 640 and applied to one of the interior-side electrodes 840, the lithium ions 880 may, in one instance, migrate through the separator 860 from the interior-side electrode 840 provided furthest away from the light source-side of the EC film 640 to the interior-side electrode 840 provided closest to the light source-side of the EC film 640 on the opposite side of the separator 860.

When the lithium ions 880 soak into the interior-side electrode 840 (which, for example, is made of polycrystalline tungsten oxide, WO3) that is provided closest to the displayable graphics side/light source-side of the EC film 640, the EC film 640 transforms to the dark state (e.g., turns opaque). When the light source 680 is provided, light from the light source 680 is reflected from the surface of the EC film 640. After the lithium ions 880 have migrated, no electric power is needed to maintain the EC film 640 in its dark state—only electric power is needed to change the EC film 640 from the dark state to the clear state. Therefore, when the EC film 640 is switched from the dark state back to the clear state, the voltage is temporarily supplied in reverse such that the EC film 640 returns to the state it was previously in, i.e., the clear state where the EC film 640 turns transparent, and when the light source 680 is provided, light from the light source 680 is allowed to pass through the transparent EC film 640. When the EC film 640 is used, the color film layer 660 matches the background color 630. It is contemplated that the switching between the clear state and the dark state may be actuated via known touch capacitance film technologies (for example, touch sensors, capacitive touch sensors, proximity sensors), power source controls (for example, engine on/off and battery on/off control switches, etc. . . . ), other multi-state vehicular functional controls, smart key proximity controls, etc. . . . .

Next, with reference to FIGS. 6-8, the operation of the display film 600 incorporating the EC film as the switchable film layer 640 will be described.

As shown in FIG. 6, in the clear state, electric power from the voltage source 670 is temporarily applied to the switchable film layer 640 such that only the background color 630 of the graphic film layer 620 is displayed on the top surface of the graphic film layer 620 (and when the light source 680 is provided, the light source 680 is illuminated such that only the background color 630 of the graphic film layer 620 is displayed on the top surface of the graphic film layer 620). In this regard, the color of the color film layer 660 is visible through the graphics area of the graphic film layer 620, which in turn causes the top surface of the graphic film layer 620 to take on the light color dead-front appearance. As shown in FIG. 7, in the dark state, electric power from the voltage source 670 is temporarily applied to the switchable film layer 640 to display the graphics 625 against the background color 630 on the top surface of the graphic film layer 620. Here, the color of the color film layer 660 cannot be visualized on the top surface of the graphic film layer 620 and instead the color of the graphics 625 matches the color of the switchable film layer 640 in the dark state.

That is, when electric power is temporarily applied to the switchable film layer 640 (where the lithium ions 880 are soaked on the interior-side electrode 840 positioned away from the light source-side of the switchable film layer 640) the lithium ions 880 migrate through the separator 860 to the interior-side electrode positioned closer to the displayable graphics side/light source-side of the switchable film layer 640 so that the switchable film layer 640 transforms to the dark state (e.g., turns opaque). When the light source 680 is provided, since the lithium ions 880 migrate through the separator 860 to transform the switchable film layer 640 to the dark state, the light from the light source 680 is reflected from the outermost side surface of the film and prevented from passing through the film layer. In the dark state, the graphics 625 are displayed against the background color 630 of the graphic film layer 620. When the graphics 625 are displayed, the graphics 625 are a color that corresponds to a color of the switchable film layer 640. In addition, when the graphics 625 are displayed, the graphics 625 are a color darker than the background color of the graphic film layer 620 against which they are displayed on the top surface of the graphic film layer 620.

When electric power is temporarily applied to the switchable film layer 640 again (where the lithium ions 880 are soaked on the outermost side of the switchable film layer 640 positioned closest to the side opposite the displayable graphics side/light source-side) the ions 880 migrate through the separator 860 back to the interior-side electrode 840 provided on the opposite side of the separator toward the displayable graphics side/furthest away from the light source-side so that the switchable film layer 640 transforms into the clear state again to display only the background color 630 which corresponds to the color of the color film layer 660. When the light source 680 is provided, the light from the light source 680 is allowed to pass through the switchable film layer 640 such that only the background color 630 which corresponds to the color of the color film layer 660 is shown on the upper surface of the display film 600. In the clear state, the display film 600 takes on the light color dead-front appearance.

Switching from the clear state to the dark state with the EC film 640 also has the above-described reveal-effect on the graphics 625 such that the graphics 625 are displayed against the background color 630 on the top surface of the graphic film layer 620. Conversely, switching from the dark state to the clear state with the EC film 640 also has the above-described fade-effect on the graphics 625 such that only the background color 630 is displayed on the top surface of the graphic film layer 620.

When the display film 600 employs the EC film as the switchable film layer 640, switching between the clear state and the dark state is perceived as instantaneous and seamless so that the graphics 625 appear repeatedly, quickly and clearly, and disappear just as quickly and smoothly. Since the displayable graphics 625 are darker in color than the background color 630 (thereby creating a strong contrast between the two colors), visibility issues associated with the conventional technology in day-time high-glare or brightness situations can also be effectively avoided. Employing the EC film thus results in an improved design aesthetic so that when, for example, the technology is applied to a vehicle control panel, the resulting transition between the display state and the light color dead-front state of the display film 600 is pleasing to the eye and reliably accurate between each transition. Additionally, due to the switching nature of the EC film, customizability of the display film 600 in both the dead-front state and in the display state is improved. Further, the EC film is capable of a high degree of transparency in the clear state, and thus the light color dead-front appearance can be more richly, uniformly and consistently displayed for a pleasing visual effect. Still further, the EC film 640 enhances power savings and reduces heat generation since electric power is based on DC voltage source 670 that only temporarily applies electric power to the switchable film layer 640 for each switch in operation state (i.e., switching between the dark state and the clear state). Moreover, since the switchable film layer 640 maintains one of the dark state and the clear state until the electric power is again temporarily applied, the graphics 625 can be reliably displayed (in the dark state) and the light color dead-front can be reliably presented (in the clear state). Since no graphics 625 are shown when the EC film is in the clear state, the background color 630 can be more clearly shown. In addition, because the light source 680 is optionally provided, further reduction in heat generation and power savings can be achieved since power is only required to change the state of the switchable film layer 640 to display the graphics 625 or present the light color dead-front appearance.

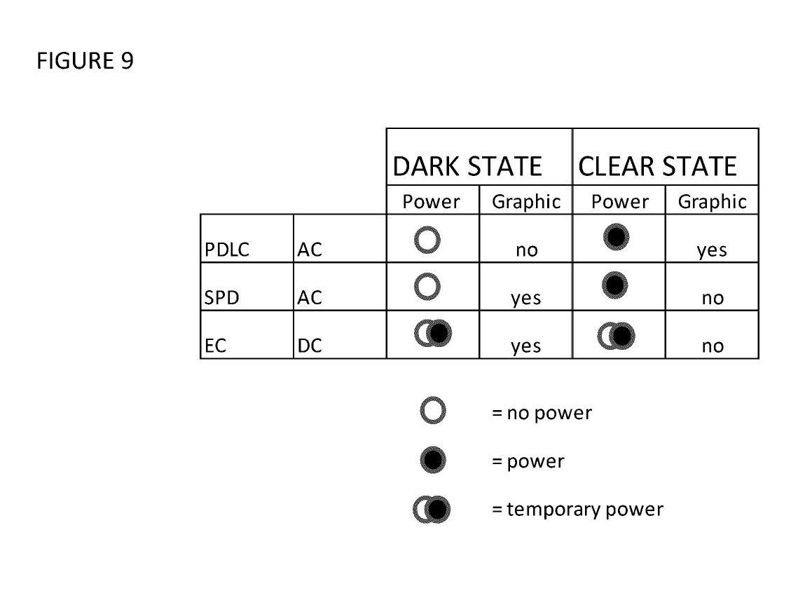

Based on the above, FIG. 9 summarizes, in chart-form, display control of the display films and operating states of the switchable film layers of the first, second and third exemplary, non-limiting embodiments.

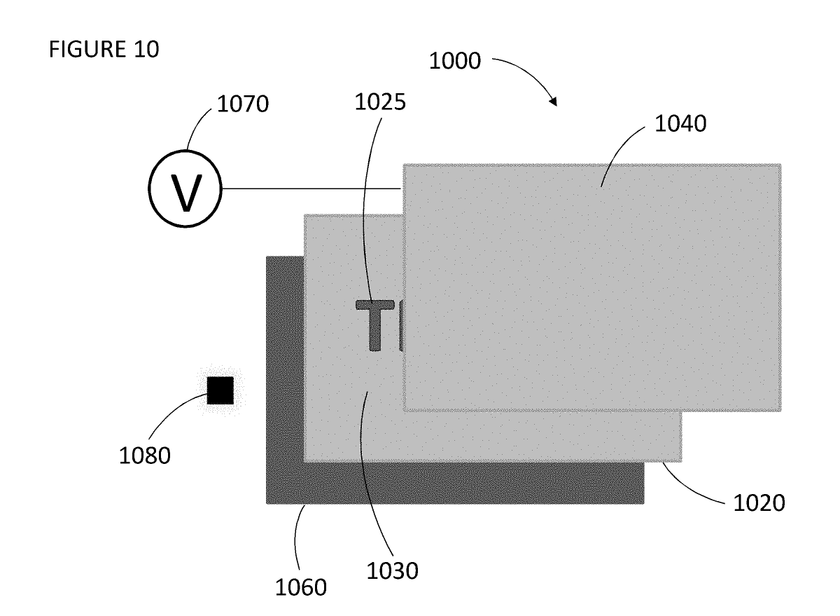

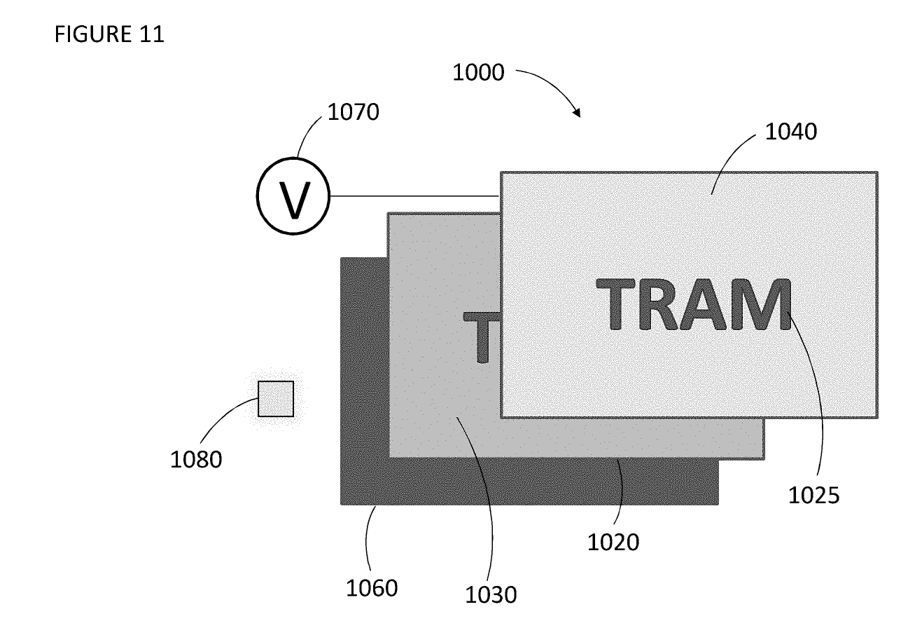

FIG. 10 shows an exploded plan view of a fourth exemplary, non-limiting embodiment of a display film 1000 in a dead-front state. FIG. 11 shows an exploded plan view of the display film 1000 in a display state. Similar to the first, second and third embodiments, the display film 1000 includes multiple film layers including a graphic film layer 1020, a switchable film layer 1040, and a color film layer 1060. However, unlike the first through third embodiments, the switchable film layer 1040 is provided at an uppermost side of the vertically stacked display film 1000 (as opposed to being provided between layers 1020 and 1060). The graphic film layer 1020 is provided between the switchable film layer 1040 at the uppermost side of the display film 1000 and the color film layer 1060 provided at a bottom-most side of the display film 1000. The graphic film layer 1020 includes displayable graphics 1025 and has a background color 1030. The background color 1030 surrounds the portion of the graphic film layer 1020 that includes the displayable graphics 1025.

Also similar to the first and second embodiments, a voltage source 1070 is connected to the switchable film layer 1040 and optionally a light source 1080 may be provided below the color film layer 1060.

In operation, when no electric power is applied to the switchable film layer 1040 (and the switchable film layer 1040 is a PDLC film), the switchable film layer 1040 is in the dark state as described above. When electric power is applied to the switchable film layer 1040, the switchable film layer 1040 is in the clear state and allows the graphics 1025 to be seen at an upper surface of the switchable film layer 1040. When the light source 1080 is provided, the light from the light source 1080 is allowed to pass through the film thereby allowing the graphics 1025 to also be seen at an upper surface of the switchable film layer 1040. In this case, in the clear state, the graphics 1025 are the same color as the color film layer 1060 and the upper surface of the switchable film layer 1040 takes on the background color 1030, although it is contemplated that the color on the upper surface of the switchable film layer 1040 may also be an overlapping blend of the color film layer 1060 and the background color 1030 so long as the blended color is lighter than the color of the graphics 1025.

When the display film 1000 employs the PDLC as the switchable film layer 1040, switching between the clear state and the dark state retains similar advantages to those advantages described above. In addition, when the switchable film layer 1040 is the uppermost layer of the display film 1000, the graphic images 1025, as well as their color(s), can be more brightly and clearly displayed. This results in an improved design aesthetic so that when, for example, the technology is applied to a vehicle control panel, the resulting transition between the display state and the light color dead-front state of the display film 1000 is pleasing to the eye and reliably accurate between each transition. It is also contemplated that when the display film 1000 employs the PDLC film as the switchable film layer 1040, the switchable film layer 1040 and the graphic film layer 1020 may be stacked in a spaced relationship such that a gap separates the two film layers.

It is further contemplated that the light source 180, 480, 680, 1080 does not necessarily need to be provided below the color film layer 160, 460, 660, 1060, nor does the light source necessarily have to be an LED. Instead, the light source may be a light (light bulb, optical fiber, etc. . . . ) that projects downward onto the upper surface of the display film 100, 400, 600, 1000 (for example, indirect illumination), or an optical light guide (disposed between the top and middle layers of the display film 100, 400, 600, 1000) that guides light towards the upper surface of the display film 100, 400, 600, 1000 from a side edge/periphery of the film layer. It is additionally contemplated that when the PDLC film is employed and the light source is provided below the color film layer, it is preferable that the color film layer have transparent qualities to allow light to pass through to illuminate the graphics (for example, not 0% transmittance and not 100% opaque). Similarly, when the SPD or EC film is employed and the light source is provided below the color film layer, it is preferable that the switchable film layer have transparent qualities to allow light to pass through to illuminate the graphics (for example, not 0% transmittance and not 100% opaque).

Accordingly, the display films described above enable graphics (e.g., vehicle functions and/or operation states) to be displayed in a way that improves driver/operator convenience while simplifying the display film structure, enhancing reliability, conserving energy, reducing heat generation, reducing manufacturing costs, and minimizing the necessity for replacement. The display films described above also improve the design aesthetic of the dead-front display panels, and enhance options and customization for light color vehicle interior styling (and other consumer products), while still effectively displaying the functions and/or operation states of the various vehicular/product systems thereon.

While the display film has been described with reference to several exemplary embodiments, it is understood that the words that have been used are words of description and illustration, rather than words of limitation. Changes may be made within the purview of the appended claims, as presently stated and as amended, without departing from the scope and spirit of the display film in its aspects. Although the display film has been described with reference to particular means, materials and embodiments, the display film is not intended to be limited to the particulars disclosed; rather the described display film configurations should be considered to extend to all functionally equivalent structures, methods, and uses such as are within the scope of the appended claims.

Although the present specification may describe components and functions that may be implemented in particular embodiments with reference to particular standards and protocols, the disclosure is not limited to such standards and protocols. For example, components of the non-limiting embodiments of the switchable film layers may represent examples of the state of the art. Such standards are periodically superseded by equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A display film, comprising:
a graphic film layer having a displayable graphic and a background color;
a switchable film layer; and
a color film layer, wherein
the switchable film layer is switchable between a clear state and a dark state when electric power is applied to the switchable film layer to either display the graphic on a top surface of the display film or only display the background color on the top surface of the display film.

2. The display film according to claim 1, wherein
when the graphic is displayed, the graphic is a color darker than the background color of the graphic film layer against which it is displayed on the top surface of the display film.

3. The display film according to claim 1, wherein
the graphic film layer is provided at an uppermost side of the display film,
the switchable film layer is provided between the graphic film layer and the color film layer, and
the switchable film layer is switchable between the clear state and the dark state when electric power is applied to the switchable film layer to either display the graphic against the background color on a top surface of the graphic film layer or only display the background color on the top surface of the graphic film layer.

4. The display film according to claim 1, wherein
the switchable film layer is provided at an uppermost side of the display film,
the graphic film layer is provided between the switchable film layer and the color film layer, and
the switchable film layer is switchable between the clear state and the dark state when electric power is applied to the switchable film layer to either display the graphic and the background color through a top surface of the switchable film layer or only display a color of the switchable film layer corresponding to the background color.

5. The display film according to claim 3, wherein
in the clear state, the graphic is displayed against the background color on the top surface of the graphic film layer, and
in the dark state, only the background color is displayed on the top surface of the graphic film layer.

6. The display film according to claim 1, wherein
when the graphic is displayed, the graphic is a color that corresponds to a color of the color film layer.

7. The display film according to claim 3, wherein
switching from the clear state to the dark state has a fade-effect on the graphic such that only the background color is displayed on the top surface of the graphic film layer, and
switching from the dark state to the clear state has a reveal-effect on the graphic such that the graphic is displayed against the background color on the top surface of the graphic film layer.

8. The display film according to claim 3, wherein
in the dark state, no electric power is applied to the switchable film layer and only the background color is displayed on the top surface of the graphic film layer, and
in the clear state, electric power is applied to the switchable film layer to display the graphic against the background color on the top surface of the graphic film layer.

9. The display film according to claim 3, wherein
in the clear state, only the background color is displayed on the top surface of the graphic film layer, and
in the dark state, the graphic contrasts with the background color to be displayed on the top surface of the graphic film layer.

10. The display film according to claim 9, wherein
the background color of the graphic film layer corresponds to a color of the color film layer.

11. The display film according to claim 9, wherein
switching from the clear state to the dark state has a reveal-effect on the graphic such that the graphic is displayed against the background color on the top surface of the graphic film layer, and
switching from the dark state to the clear state has a fade-effect on the graphic such that only the background color is displayed on the top surface of the graphic film layer.

12. The display film according to claim 3, wherein
when electric power is applied to the switchable film layer in the dark state, the switchable film layer is switched to the clear state such that only the background color is displayed on the top surface of the graphic film layer, and
when electric power is applied to the switchable film layer in the clear state, the switchable film layer is switched to the dark state such that the graphic is displayed against the background color on the top surface of the graphic film layer.

13. The display film according to claim 3, wherein
in the dark state, no electric power is applied to the switchable film layer such that the graphic is displayed against the background color on the top surface of the graphic film layer, and
in the clear state, electric power is applied to the switchable film layer such that only the background color is displayed on the top surface of the graphic film layer.

14. The display film according to claim 1, wherein
the switchable film layer is configured to continuously receive the electric power in the clear state.

15. The display film according to claim 1, wherein
the switchable film layer is configured to temporarily receive the electric power to switch between the clear state and the dark state.

16. The display film according to claim 1, wherein
the electric power is alternating current voltage.

17. The display film according to claim 1, wherein
the electric power is direct current voltage.

18. The display film according to claim 1, wherein
the switchable film layer is a polymer disbursed liquid crystal film.

19. The display film according to claim 1, wherein
the switchable film layer is a suspended polymer device film layer.

20. The display film according to claim 1, wherein
the switchable film layer is an electrochromic film layer.
